(19) United States
(12) Patent Application Publication
(10) Pub. No.: US 2023/0177493 A1
(43) Pub. Date: Jun. 8, 2023

(54) SYSTEM AND METHOD FOR AN ELECTRONIC WALLET WITH ENHANCED CRYPTOCURRENCY HANDLING AND SECURITY FOR DEBIT CARD TRANSACTIONS

(71) Applicant: ORIGINAL DIGITAL CORPORATION, Houston, TX (US)

(72) Inventors: JOEL R. BINN, FORT LEE, NJ (US); PAUL CALDWELL, HOUSTON, TX (US)

(73) Assignee: ORIGINAL DIGITAL CORPORATION, Houston, TX (US)

(21) Appl. No.: 17/936,638

(22) Filed: Sep. 29, 2022

Related U.S. Application Data
(60) Provisional application No. 63/249,973, filed on Sep. 29, 2021.
(60) Provisional application No. 63/249,948, filed on Sep. 29, 2021.

(51) Int. Cl. G06Q 20/36; G06Q 40/04; G06Q 20/10; G06Q 20/34; G06Q 20/26

(52) U.S. Cl. CPC G06Q 20/3678; G06Q 40/04; G06Q 20/108; G06Q 20/351; G06Q 20/26; G06Q 20/3672; G06Q 2220/00

(57) ABSTRACT

A system and method for providing an electronic wallet characterized by enhanced cryptocurrency handling and security for debit card transactions includes a control computer, a financial information exchange server, a transfer server, and a wallet banking platform in communication with the electronic wallet. The wallet includes a virtual debit card, and the system allows a user to instantly load funds on to the debit card using a hand-held computing device upon which the electronic wallet software application resides. The electronic wallet system provides a firewall between the debit card and the user's traditional bank account(s).

### CROSS REFERENCE TO RELATED APPLICATIONS

This application is based on and claims benefit of U.S. provisional patent application Ser. No. 63/249,973, filed on Sep. 29, 2021 and entitled “System And Method for an Electronic Wallet with Enhanced Cryptocurrency Handling,” and U.S. provisional patent application Ser. No. 63/249,948, filed on Sep. 29, 2021 and entitled “Electronic Wallet With Enhanced Security for Debit Card Transactions.” The priorities of these applications is claimed.

### TECHNICAL FIELD

The present disclosure relates generally to systems and methods for facilitating secure consumer financial transactions using debit cards and cryptocurrencies.

### BACKGROUND

A cryptocurrency is a digital asset designed to work as a medium of exchange that uses strong cryptography to secure financial transactions, control the creation of additional units, and verify the transfer of assets. Cryptocurrencies use decentralized control as opposed to centralized digital currency and central banking systems. The decentralized control of each cryptocurrency works through distributed ledger technology, typically a blockchain, that serves as a public financial transaction database. Bitcoin, first released as open-source software in 2009, is generally considered the first decentralized cryptocurrency. Since the release of bitcoin, over 4,000 alternative variants of bitcoin, or other cryptocurrencies have been created. Cryptocurrency exchanges allow customers to trade cryptocurrencies for other assets, such as conventional fiat money, or to trade between different digital currencies.

A cryptocurrency wallet, or electronic wallet, is a software application that allows cryptocurrency users to store, retrieve, trade, or exchange their digital cryptocurrency assets. As with conventional currency, one does not need a wallet to spend cash, but an electronic wallet certainly helps to keep all one's cryptocurrency in one place and may provide additional functionality for purchasing, trading or selling cryptocurrency, or for making purchases online or in brick-and-mortar retail establishments using cryptocurrency.

Electronic wallets are applications that might run on a smartphone or computer. The first cryptocurrency wallet was introduced by Satoshi Nakamoto when he first released the bitcoin protocol in 2009. Bitcoin is the most popular and widely used cryptocurrency, but others building upon its blockchain technology have emerged, and any of them can be stored on a typical electronic wallet.

When one wants to acquire cryptocurrency, whether by purchasing it in a currency exchange or receiving it as a gift or as revenue, one directs the sender to a unique cryptographic address issued by the electronic wallet. The electronic wallet does not actually store the cryptocurrency, but the information stored on the electronic wallet points to cryptocurrency's location on the blockchain, the public ledger that records and authenticates all transactions for a cryptocurrency. Spending with an electronic wallet may as simple as scanning a retailer's Quick Response (QR) code or directing a specific amount of cryptocurrency to the retailer's public address.

A current limitation exists in cryptocurrency transactions in light that there are only few online or brick-and-mortar stores where cryptocurrencies can be used to purchase goods. Additionally, latency in trading or exchanging cryptocurrency and its concomitant liquidity issues pose an obstacle to flourishing use cryptocurrency.

More and more consumers are purchasing items and services over electronic networks such as, for example, the Internet. The transactions may take place directly between a conventional or on-line merchant or retailer and the consumer, and payment is typically made by entering credit card, debit card, or other financial information.

Transactions may also take place with the aid of an on-line or mobile payment service provider such as PayPal, Google Pay, or Apple Pay. Such payment service providers can make transactions easier and safer for the parties involved. Purchasing with the assistance of a payment service provider from the convenience of virtually anywhere using a mobile device is one main reason why on-line and mobile purchases are growing very quickly.

An electronic wallet, is a software application that might run on a smartphone or computer that allows users to make purchases online or in brick-and-mortar retail establishments. An electronic wallet may store the user's bank account, debit card and credit card details, allowing the user to select which form of payment to use.

Payment service providers sometimes provide electronic wallets to their users that include user payment accounts that are provided by the payment service provider and that allow the user to make payments for purchases and/or other expenses. In addition, a user may link their financial accounts such as, for example, checking accounts, savings accounts, credit accounts, and/or a variety of other financial account known in the art, to their electronic wallet in order to fund their user payment account for making purchases. Furthermore, different users of the payment service provider may transfer funds between their respective electronic wallets. As such, electronic wallets provided by the payment service provider may be funded by the users of those electronic wallets using their financial account, or through payments or other fund transfers from other users with electronic wallets.

PayPal has been in the mobile payments business for well over a decade. It is an online financial service that allows one to pay for items using a secure internet account. One simply adds bank account, credit card or debit card details and whenever paying using PayPal, one can choose which of registered cards or accounts is used for payment. In addition to paying for items using PayPal, one can also receive money through the service. Any money received sits in a PayPal account and can be used when paying for something, with the balance topped up by the registered cards or bank account.

A Google Pay user adds a credit or debit card to their Google Pay app. Google Pay requests a token to represent the card they are trying to add from the bank that issued that card. Once the token is issued, this card is now “tokenized,” meaning it has a unique identification number associated with it. Google Pay encrypts the newly tokenized card and it is ready to be used for payments. To make a purchase, a customer taps their mobile device on a point-of-sale terminal or chooses to pay in the mobile application. Google Pay responds with the customer's tokenized card and a cryptogram which acts as a one-time-use password. The card network validates the cryptogram and matches the token with the customer's actual card number. The acquiring bank and the customer's card issuing bank use existing customer information and decrypted customer billing information to complete the transaction. That is, Google Pay doesn't process or authorize transactions, it merely helps enable secure and speedy transactions by tokenizing cards and passing this tokenized card and other customer information to credit card networks.

Apple Pay is a contactless payment technology for Apple devices. It was designed to move consumers away from physical wallets into a world where your debit and credit cards are on an iPhone or Apple Watch, allowing one to pay using one's device instead of a physical card. Apple Pay supports most major credit and debit cards providers including Visa, MasterCard and American Express. One needs to use a participating bank but most major banks now support Apple Pay. Apple Pay works anywhere that accepts contactless payments. One needs to use the Apple Wallet application to setup Apple Pay on an iPhone or iPad. The Apple Wallet will then store credit cards and debit cards, pulling the data when one authenticates Apple Pay to pay for goods.

As described above, electronic wallets provide useful features, including the user not having to re-enter credit card information for every online transaction, which exposes the card number to unknown parties, and contactless payment at merchants and kiosks. Yet, despite the many conveniences provided by electronic wallets, electronic wallets remain essentially just that—a wallet. In essence, today's electronic wallets function as a pass-through device, because money transactions still occur between the acquiring bank and the customer's bank using existing customer banking information, such as debit card and credit card numbers.

Although credit cards provide a level of fraud protection against fraudulent use, debit cards are particularly vulnerable. It is desirable, therefore, to provide an electronic wallet that allows debit card payments having greater security.

### BRIEF DESCRIPTION OF THE DRAWINGS

Many aspects of the present disclosure can be better understood with reference to the following drawings, in which:

FIG. 1 is a block view of a system and method for an electronic wallet with enhanced cryptocurrency handling according to one or more embodiments;

FIG. 2 is a block view of a system and method for an electronic wallet with enhanced security for debit card transactions according to one or more embodiments; and

FIG. 3 is a block view of a system and method for an electronic wallet with both enhanced security for debit card transactions and enhanced cryptocurrency handling according to one or more embodiments.

The components in the drawings are not necessarily to scale, with emphasis instead being placed upon clearly illustrating the principles of the disclosure. Moreover, in the drawings, like reference numerals designate corresponding parts throughout the several views.

### DETAILED DESCRIPTION

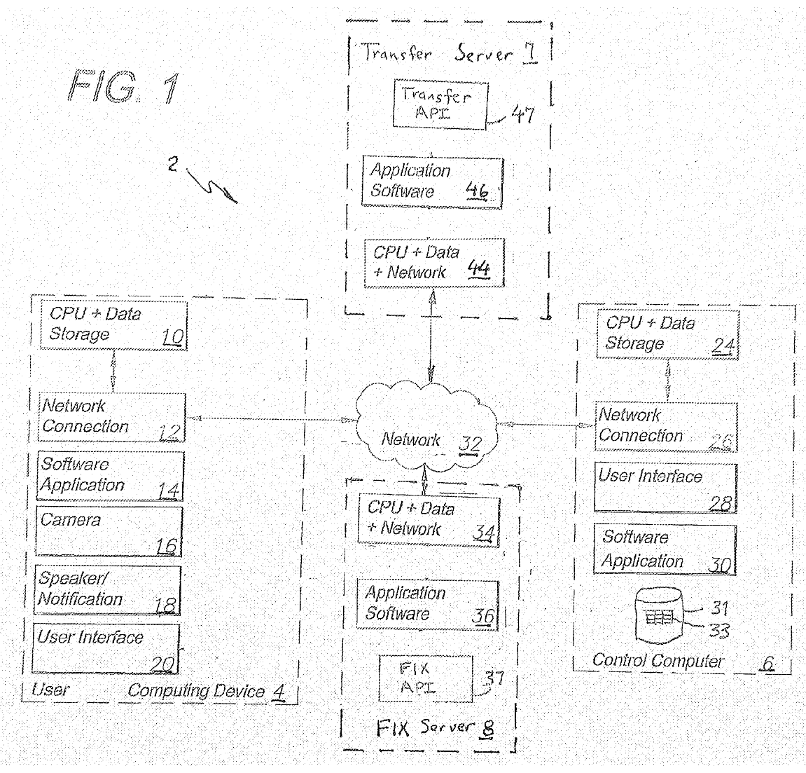

FIG. 1 is a block view of a system 2 and method for an electronic wallet according to one or more embodiments. Referring to FIG. 1, a user's computing device 4, such as a typical smart phone, tablet, or other computer device, is in communication with a control computer 6 via a network 32, such as the internet or a wireless network.

The computing device 4 includes standard elements including a CPU and data storage 10, network connection 12 for connecting to network 32, a software electronic wallet application 14 stored in the data storage and used to interface with the other elements. As is typical, computing device 4 may include A camera 16, a speaker 18 or other notification device (e.g. vibration, flashing lights), and a user interface 20, such as a touchscreen. As computer technology is well known to routineers in the art, further detail need not be provided herein.

The control computer 6 similarly includes a CPU and data storage 24, a network connection 26 for communicating through network 32, a user interface 28, a software application 30, and a database 31.

A Financial Information Exchange (FIX) server 8 is also be connected to network 32. FIX server 8 similarly includes a CPU, data storage, and network connection 34, as is known in the art. FIX server 8 includes proprietary market trading application software 36 typically used by liquidity providers, traders (retail and institutional) and regulators to address the markets on an ongoing basis. Trading application software 36 is in turn operatively coupled to a FIX application programming interface (API) 37.

FIX API 37 adheres to a set of clearly defined rules and methods designed specifically for the electronic transfer of financial data. In the nomenclature of the financial industry, it is the electronic communications protocol for real-time information exchange for financial securities transactions. The FIX protocol fosters a seamless flow of real-time data between market participants.

The primary function of the FIX protocol is to facilitate the transfer of three distinct types of data: Pre-trade information used in crafting strategies and decisions for implementation on the market, including levels of liquidity, order flow and depth-of-market statistics streaming directly from exchange or market servers; trade-related information focused on the act of conducting trade, including order entry, confirmation and execution functions; and post-trade data that aids in the recording, processing and transfer of asset ownership involved with market-based transactions.

The FIX Protocol allows for a rapid transfer of vast quantities of information. It employs a standardized language and enjoys widespread acceptance The FIX Protocol was originally developed in 1992 by Robert Lamoureux and Chris Morstatt. From its onset, FIX was designed to promote efficiency in trade-related communications. Today, FIX Protocol 4.4 is a popular tool for active traders, both retail and institutional. It features robust performance, and facilitates as many as 250 price updates per second.

In one or more embodiments, FIX server 8 is ideally operated by a low latency trading platform, such as Blockfills. Blockfills is a disruptive technology firm dedicated to the provision of bespoke end-to-end solutions to participants in the cryptocurrency market the world over. Blockfills solves fragmented liquidity problems through aggregation and matching algorithms. However, any suitable provider that can supply a constant stream of updated market bids and asks and effect cryptocurrency trades may be used within the scope of the present disclosure.

A settlement and transfer server 7 is also be connected to network 32. Transfer server 7 similarly includes a CPU, data storage, and network connection 44, as is known in the art. Settlement and transfer server 7 includes proprietary transfer and settlement application software 46 that effects transfer of cryptocurrency between electronic wallets. Transfer and settlement application software 46 is in turn operatively coupled to a transfer API 37. In one or more embodiments, transfer server 7 is ideally operated by a digital asset custody, transfer and settlement platform, such as Fireblocks. However, any suitable platform that can safely and reliably effect cryptocurrency transfers may be used within the scope of the present disclosure.

Fireblocks Network is an institutional asset transfer network that completely mitigates the risks associated with deposit addresses by automating deposit address authentication and rotation. The Fireblocks Network entirely removes the need for copy-pasting deposit addresses and then authenticating them using time-consuming and risky test transfers and whitelisting procedures. Without an authentication network, it is possible for assets to be lost through deposit address spoofing or human errors, such as entering a deposit address for a counterparty that has already been rotated out.

Institutions on the Fireblocks Network settle trades within seconds, without the possibility of asset loss due to a deposit address attack or error. The Fireblocks Network is built using a patent-pending technology that is using the latest breakthroughs in secure enclave technology and data-in-motion encryption. The sending wallet opens an encrypted tunnel with the recipient wallet to query for the deposit address to send the transaction to. The encrypted tunnel is protected within a secure enclave (hardware termination) on both the sending wallet and receiving wallet. U.S. Published Patent Application No. 2021/0224797, filed on Feb. 10, 2021 and entitled “System and Method for Securing Crypto-Asset Transactions” is incorporated herein by reference.

Electronic wallet 14 is preferably designed and arranged to allow its user to buy or sell cryptocurrency. The cryptocurrency buying/selling process, according to one or more embodiments, is based upon integration with FIX API 37 to provide market values and process requests to buy or sell cryptocurrencies. FIX server 8 provides a constant stream of updated market bids and asks. In one or more embodiments, those values are retrieved periodically by control computer 6 and a database table 33, stored in database 31, is updated with those values. Preferably, market bids and asks are updated in database table 33 every fifteen seconds, although a different refresh rate may be used as appropriate.

When a user of electronic wallet application 14 requires the display market values, the latest vales from database table 33 of control computer 6 are retrieved and sent via network 32 to computing device 4 for display on user interface 20, as will be understood by practitioners in the art. When a user of electronic wallet application 14 wishes to buy or sell a cryptocurrency, the request is sent from computing device 4 to control computer 6, which in turn with FIX API 37 to send the request to FIX server 8. The operator of FIX server 8 executes the request or returns a failure message.

In one or more embodiments, if the request is to purchase cryptocurrency, software application 30 in control computer 6 ensures the customer has enough funds held in electronic wallet application 14, plus ten percent or other suitable amount, to cover the Buy. The user's cryptocurrency portfolio within electronic wallet application 14 will be incremented for a Buy or decremented for a Sell by the amount of the trade for the selected cryptocurrency by control computer 6.

Electronic wallet 14 is also preferably designed and arranged to allow its user to send or receive cryptocurrency. The cryptocurrency sending/receiving process, according to one or more embodiments, is based upon integration of control computer 6 running software application 30 with Transfer API 47.

When a user of electronic wallet application 14 is going to receive cryptocurrency from an outside repository, they must select on application 14 which type of cryptocurrency they will be receiving. Electronic wallet application 14 sends a request via network 32 to Transfer API 47 to provide the address of the user's electronic wallet application 14 for that flavor of cryptocurrency. If the user does not have an existing wallet address for that currency type, transfer and settlement application software 46 running on transfer server 7 creates one. In either case, a cryptocurrency wallet address is transferred back to electronic wallet application 14 for display on user interface 20 to the user who may then provide that address to the organization that will send the cryptocurrency to that user's wallet address. When the process is completed, the amount of cryptocurrency added to the customer's crypto currency wallet will be incremented by that amount.

When the user of electronic wallet application 14 wishes to send cryptocurrency to an outside repository, the user must first decide which type cryptocurrency they wish to send. The user must then inquire the address of the wallet to which the cryptocurrency will be sent from the outside repository. With that information, if the user has enough cryptocurrency in that type, electronic wallet application 14 sends the request via network 32 to Transfer API 47. The request includes the cryptocurrency type, the amount of cryptocurrency to send, and the recipient's wallet address for that cryptocurrency. Transfer and settlement application software 46 running on transfer server 7 initiates the Send and returns a success or failure message when the process has completed.

One or more embodiments facilitate a merchant to accept cryptocurrency payments. Those payments can originate within current electronic wallet application 14 or from outside repositories or exchanges such as CoinBase. The only requirement is to have the merchant display the cryptocurrency address of the designated cryptocurrency (or currencies) they accept. In a preferred embodiment, this would not be a static address that is hard coded but rather is retrieved from transfer server 7 with each request, as the receiving wallet address could change.

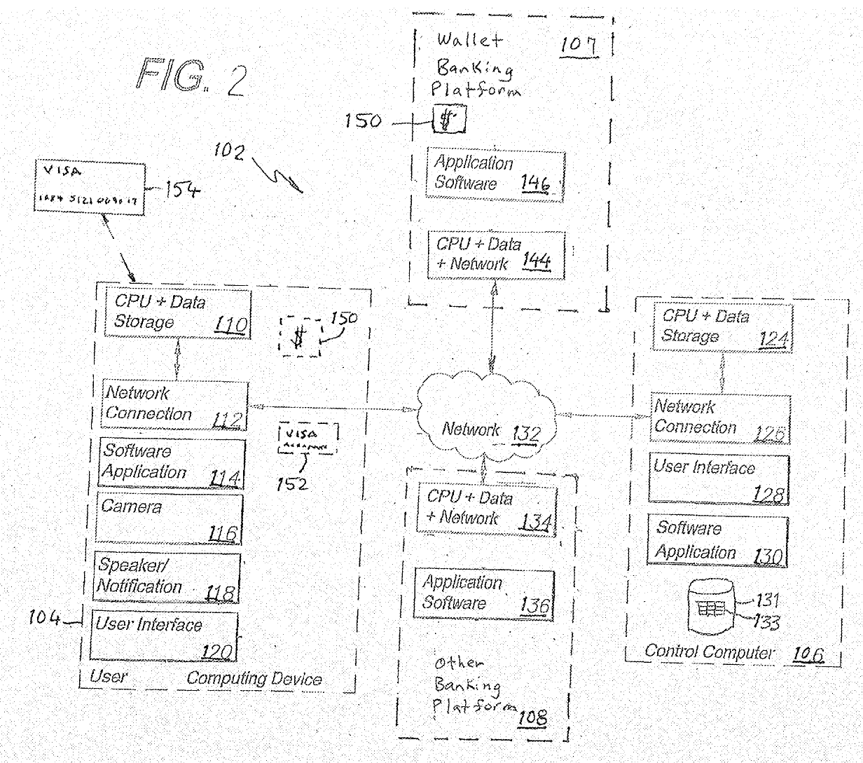

FIG. 2 is a block view of a system 102 and method for an electronic wallet according to one or more embodiments. Referring to FIG. 2, a user's computing device 104, such as a typical smart phone, tablet, or other computer device, is in communication with a control computer 106 via a network 132, such as the internet or a wireless network.

The computing device 4 includes standard elements including a CPU and data storage 110, network connection 112 for connecting to network 132, a software electronic wallet application 114 stored in the data storage and used to interface with the other elements. As is typical, computing device 104 may include A camera 116, a speaker 118 or other notification device (e.g. vibration, flashing lights), and a user interface 120, such as a touchscreen. As computer technology is well known to routineers in the art, further detail need not be provided herein.

The control computer 106 similarly includes a CPU and data storage 124, a network connection 126 for communicating through network 132, a user interface 128, a software application 130, and a database 131.

System 2 further includes a wallet banking platform 107, which includes a CPU, data and network interface 144 and banking application software 146. Also attached to network 132 are one or more other independent banking platforms (only one system 108 is shown for brevity), which may represent a bank used by the user of computing device 104 or by another party, such as a merchant, for example. Banking platform 108 includes CPU, data and network interface 134 and banking application software 136, as is known in the art.

Control computer 106 interfaces with computing device 104 to operate electronic wallet 114. In a preferred embodiment, electronic wallet 114 “includes” a cash account 150, which may be represented by a ledger 131 maintained in database 131 of control computer 106; the actual cash account associated with electronic wallet 114 is maintained by wallet banking platform 107. Preferably the electronic wallet cash account is secured in an FDIC insured interest bearing US Dollar denominated account maintained by wallet banking platform 107.

As with typical electronic wallets of prior art, electronic wallet 114 allows the user to link it with his or her checking and/or savings accounts, credit cards, debit cards, et cetera. Such accounts may be housed at banking platform 8, for example. Accordingly, electronic wallet 114 allows the user to load money from checking and savings accounts, credit and debit cards and cash around the world to at any time, using Automatic Clearing House (ACH) transfers, domestic or international wire transfers, foreign currency transfers (FX), direct deposits, or other means known within the art, either extant or yet to be developed.

Electronic wallet 114 further includes a virtual debit card 152. In a preferred embodiment, virtual card 152 is a Visa debit card available for immediate use anywhere Visa is accepted worldwide. Virtual card 152 is associated with wallet cash account 150, but not in the traditional sense that debit card is associated with a bank account. In the traditional sense, a debit card associated with a bank account exposes the entire back account balance at all times to a debit card transaction, subject to certain imposed maximum transaction amounts. However, virtual card 152 acts more as a prepaid card. A user may instantly load any desired amount of money from wallet cash account 150 to virtual card 152 using easy-to-navigate controls in electronic wallet. This action causes computing device 104 to transmit that data to control computer 106 and wallet banking platform 107, which in turn immediately update the virtual card balance.

In one or more embodiments, each individual electronic wallet has a corresponding individual cash account 150 in wallet banking platform. In other embodiments, cash account 150 may be an omnibus account shared by multiple electronic wallets, and control computer 106 maintains a ledger of account balances of each wallet.

In one or more embodiments, electronic wallet 114 is further configured to operate with a physical debit card 154, which can be instantly loaded with funds from wallet cash account 150 in the same manner as virtual debit card 152. Physical debit card 154 and virtual debit card 152 have different account numbers, and may be used in tandem or whichever is preferred for any particular situation. Physical debit card 154 is particularly useful at gas pumps, automated teller machines (ATMs), other kiosks not equipped for contactless payments, restaurants, et cetera. For example, having just received the bill at a fine restaurant, a user can instantly load, using electronic wallet 114, the exact amount of funds needed to pay the bill onto physical debit card 154. When the waiter takes the card out of sight of the user, the user can be assured that an additional transaction is not processed depleting the account of funds.

Electronic wallet 114 is compatible with other payment service providers, including PayPal, Google Pay, Apple Pay, and the like. Virtual debit card 152 or physical debit card 154 is simply linked to a user's PayPal, Google Pay or Apple Pay wallet, which can then be used to process payments. Regardless, by keeping limited funds loaded to virtual debit card 152 or physical debit card 154 until a transaction is desired, electronic wallet 114 provides a firewall to protect the user's cash account.

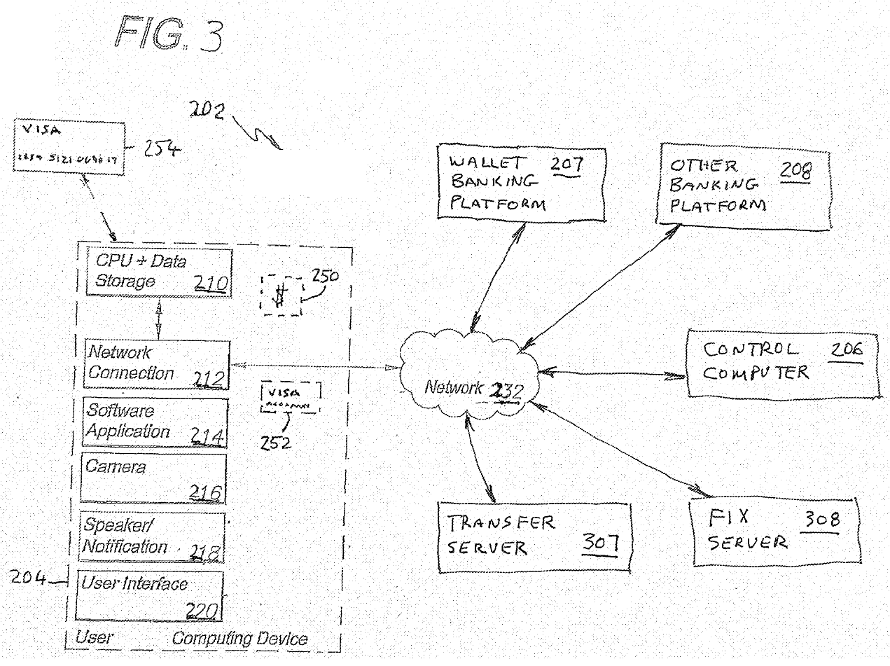

FIG. 3 is a block view of a system 202 and method for an electronic wallet according to one or more embodiments, which includes components for both enhanced security for debit card transactions and enhanced cryptocurrency handling according to one or more embodiments. Referring to FIG. 3, a user's computing device 204, such as a typical smart phone, tablet, or other computer device, is in communication with a control computer 206 via a network 232, such as the internet or a wireless network.

The computing device 204 includes standard elements including a CPU and data storage 210, network connection 212 for connecting to network 232, a software electronic wallet application 214 stored in the data storage and used to interface with the other elements. As is typical, computing device 204 may include a camera 216, a speaker 218 or other notification device (e.g. vibration, flashing lights), and a user interface 220, such as a touchscreen. As computer technology is well known to routineers in the art, further detail need not be provided herein.

Control computer 206 similarly includes a CPU and data storage, a network connection for communicating through network, a user interface, a software application, and a database, substantially as described supra with respect to control computer 6 of FIG. 1 or control computer 106 of FIG. 2.

Control computer 206 interfaces with computing device 204 to operate electronic wallet 214. Substantially as described with respect to the system and method of FIG. 2, electronic wallet 214 “includes” a cash account 250, which may be represented by a ledger maintained in a database of control computer 206; the actual cash account associated with electronic wallet 214 is maintained by a wallet banking platform 207. Banking platform 207 is substantially similar to banking platform 107 of FIG. 2. Electronic wallet 214 further includes a virtual debit card 252, in a manner substantially as described above with respect to FIG. 2.

System 202 further includes banking platform 208, which is substantially identical to banking platform 108 of FIG. 2, transfer server 307, which is substantially identical to transfer server 7 of FIG. 1, and FIX server 308, which is substantially identical to FIX server 8 of FIG. 1.

It will be understood from the foregoing description that modifications and changes may be made in various embodiments of the present invention without departing from its true spirit. The descriptions in this specification are for purposes of illustration only and are not to be construed in a limiting sense.

The present invention may be embodied in part as computer readable code on computer readable media, including any computer data storage device such as magnetic storage devices, optical storage devices or ROM storage devices. The computer readable code may also be distributed over a network between computer systems so that it is stored and executed in a distributed fashion.

The Abstract of the disclosure is solely for providing the a way by which to determine quickly from a cursory reading the nature and gist of technical disclosure, and it represents solely one or more embodiments.

While various embodiments have been illustrated in detail, the disclosure is not limited to the embodiments shown. Modifications and adaptations of the above embodiments may occur to those skilled in the art. Such modifications and adaptations are in the spirit and scope of the invention.

What is claimed is:

1. An electronic wallet system comprising:
a user computing device having a processor, memory, a user interface, and a network connection, said user computing device being operable to execute a software application thereon;
an electronic wallet software application installed on and executed by said user computing device, said electronic wallet software application defining an electronic wallet adapted for storing cryptocurrency and access to fiat currency funds;
a control computer disposed remotely from said user computing device and in communication with said user computing device, said control computer including a database of cryptocurrency market values and wallet cash account values;
a financial information exchange server in communication with said control computer, said financial information exchange server including an application programming interface coupled to said control computer whereby said control computer is operable to retrieve cryptocurrency market values from said financial information exchange server via said application programming interface and store said market values in said database;
a settlement and transfer server in communication with said control computer operable to effect transfer of cryptocurrency to or from said electronic wallet at the request of said control computer;
a wallet banking platform in communication with said control computer, said banking platform including a cash account, said control computer operable to maintain within said database a ledger of value of said cash account that is associated with said electronic wallet; and
a debit card issued by said wallet banking platform included in said electronic wallet, said control computer operable to direct said wallet banking platform to load a selected amount of funds from said cash account to said debit card at the request of said electronic wallet software application.
